(19) United States
(12) Patent Application Publication
(10) Pub. No.: US 2024/0010324 A1
(43) Pub. Date: Jan. 11, 2024

(54) COMPOSITE MULTI-SPAR AIRCRAFT LIFTING SURFACE

(71) Applicant: Airbus Operations S.L.U., GETAFE (ES)

(72) Inventors: Mario LINARES VILLEGAS, GETAFE (ES); Paula ÁLVAREZ LLORIÁN, GETAFE (ES); Francisco José PARRA VILLACORTA, GETAFE (ES); Marina GALLI, GETAFE (ES); Alain KADIRI MORENO, GETAFE (ES); Javier Carlos GÓMEZ DEL VALLE, GETAFE (ES); Robert KOBIERECKI, GETAFE (ES); María Beatriz AVILÉS TORREGROSA, GETAFE (ES); María José GARCÍA BLANCO, GETAFE (ES); Ángel POSTIGO RODRÍGUEZ, GETAFE (ES)

(21) Appl. No.: 18/348,085

(22) Filed: Jul. 6, 2023

(30) Foreign Application Priority Data
Jul. 7, 2022 (EP) 22382649.6

(51) Int. Cl. B64C 3/18; B64F 5/10

(52) U.S. Cl. CPC B64C 3/185; B64C 3/187; B64F 5/10

(57) ABSTRACT

A composite multi-spar aircraft lifting surface comprising an integrated torsion box having a first portion of a skin continuous on the second face from a right tip to a left tip, a second portion of a skin continuous on the lateral right side of the first face from a right tip to a first central portion, a third portion of a skin continuous on the lateral left side of the first face from the left tip to a second central portion, a cover spanning between the first central portion and the second central portion. The spars, the first portion of the skin, the second portion of the skin and the third portion of the skin being an integrated multi-cell part. Also a method of manufacturing such a lifting surface.

### CROSS-REFERENCES TO RELATED APPLICATIONS

This application claims the benefit of European Patent Application No. 22382649.6 filed on Jul. 7, 2022, the entire disclosure of which is incorporated herein by way of reference.

### FIELD OF THE INVENTION

The present invention is directed to the manufacture of aircraft lifting surfaces such as horizontal tail planes (HTP) or wings. The invention allows the complete integration of a tip-to-tip composite torsion box.

### BACKGROUND OF THE INVENTION

It is known that lifting surface architectures for aircrafts comprise two swept torsion boxes, a lateral right side and lateral left side, with a central joint at the aircraft centerline. Each lateral side is located with respect to a longitudinal direction of the torsion box. Said longitudinal direction is contained in a symmetry plane of the torsion box. Once assembled in an aircraft, the longitudinal direction of the torsion box may be comprised in a vertical longitudinal plane of symmetry of the aircraft's envelope.

The torsion box also includes a first face and a second face spaced in a Z-direction of the torsion box comprising skin panels forming the first face and the second face. The Z-direction may be orthogonal to the longitudinal direction.

The first face may correspond to an upper face or suction side of the airfoil and the second face may correspond to a lower face or pressure side of the airfoil or the other way around.

Eventually, a central torsion box is used instead of a central joint depending on the aircraft architecture.

The most widespread structure for a torsion box is formed by front and rear spars and a plurality of ribs transversally arranged and fitted to front and rear spars, such as to form a box-like configuration. The torsion box also includes upper and lower skin panels internally reinforced by stringers. The main functions of the ribs are to provide torsional rigidity, longitudinally limit the skins and the stringers so as to discretize buckling loads, maintain the shape of the aerodynamic surface and support local load introductions resulting from actuator fittings, support bearings, and similar devices, which are directly secured to the front and rear ribs.

It is also known the multi-spar torsion box structure wherein the ribs are dispensed with, and several spars are introduced for creating closed cells in order to replace the functions of the ribs of the previous design. The spars are located in the lateral left side and in the lateral right side and run spanwise. The multi-spar torsion box is manufactured with modular tooling which is combined in different manners in order to simplify its demolding.

Several proposals have been developed for a composite fiber reinforced polymer Horizontal Tail Plane (HTP) based on a tip-to-tip torsion box wherein both the lateral left side and the lateral right side are integrated with a continuous skin made as a single part.

Integrated means that the individual elements are cured together as a result forming a single piece comprising all the individual elements.

The proposed invention aims to simplify an integrated tip to tip and multi-spar concepts, solving the disadvantages that they present and combining their advantages.

### SUMMARY OF THE INVENTION

The invention enables the manufacture of an integrated multi-spar torsion box which allows for a high degree of automation in manufacturing and assembly.

The torsion box of the composite multi-spar aircraft lifting surface comprises:
a first portion of the skin being continuous on the second face from a right tip of the lateral right side to a left tip of the lateral left side,
a second portion of the skin being continuous on the lateral right side of the first face, from the right tip to a first central portion of the torsion box,
a third portion of the skin being continuous on the lateral left side of the first face, from the left tip to a second central portion of the torsion box,
a cover spanning at least partially between the first central portion and the second central portion of the torsion box. In a shown embodiment, the cover spans between the first central portion and the second central portion across the whole length of the chord. It is also possible for the cover to span between the first central portion and the second central only partially along the length of the chord.

The spars, the first portion of the skin, the second portion of the skin and the third portion of the skin are an integrated multi-cell part, i.e., these elements are configured in one piece. The spars, the first portion of the skin, the second portion of the skin and the third portion of the skin are integral and represent functional portions of an integrated part.

Continuous means that it is made in one piece, i.e., cured together as a sole piece. Therefore, each cell of the multicell structure is formed by two consecutive spars and the upper and lower skins that are continuous.

According to the above, an opening exists in the first face between the first central portion and the second central portion which is closed by the cover.

This invention presents a composite tip-to-tip and multi-spar torsion box structure in a single part for a lifting surface, for instance, a horizontal tail plane (HTP). It includes a multi-cell structure of spars and skins extending along the complete span. The claimed invention removes the conventional central joint and allows a better access to the inside of the torsion box than a multi-spar configuration simplifying installation and allowing high automatization.

The opening between the second portion of the skin and the third portion of the skin, i.e., the opening between the first central portion and the second central portion, which is subsequently occupied by the cover, allows access to the inside of the torsion box. As a result, a modular tooling manufacturing concept allowing the removal of the internal tooling from the manufactured torsion box through the mentioned opening is provided.

The spars, the first portion of the skin, the second portion of the skin and the third portion of the skin are configured as an integrated multi-cell structure in one piece. Thus, by any manual or automatic process the plies are stacked, the tooling is located within the structure of the torsion box and the whole structure is consolidated by applying a single pressure and temperature cycle.

The claimed invention offers the following advantages:
Greater integration.
Removal of lifting surface central joint.
Skin optimization at the central zone thanks to the continuous skins that allows a better load transmission.
High automatic riveting.
Better access to the inside of the torsion box than conventional multi-spar lifting surfaces reducing assembly time.
Reduction of the number of fasteners that leads to a reduction in weight and assembly time.
Automatic riveting for cover installation by means of High Strength Blind Fastener.
Access to the inside of the torsion box thanks to the opening left between the second portion of the skin and the third portion of the skin wherein the cover is located afterwards. This access can be placed indistinctly in the upper or in the lower skins and its size can be adapted to the tooling and assembly needs. The mentioned access allows:
   Removing tooling after curing.
   Access for fitting, ribs and system installation.
   Access for inspections after curing.

The invention also provides a manufacturing method comprising the following steps:
in a first step, manufacturing the torsion box as an integrated multi-cell part comprising:
   the spars,
   a first portion of the skin being continuous on the second face from a right tip of the lateral right side to a left tip of the lateral left side,
   a second portion of the skin being continuous on the lateral right side of the first face, from the right tip to a first central portion of the torsion box, and
   a third portion of the skin being continuous on the lateral left side of the first face, from the left tip to a second central portion of the torsion box, leaving an opening in the skin between the first central portion and the second central portion. The opening is configured to provide access to the integrated multi-cell part,
in a second step, fastening a cover spanning at least partially onto the opening.

### BRIEF DESCRIPTION OF THE DRAWINGS

To complete the description and to provide for a better understanding of the invention, a set of drawings is provided. Said drawings form an integral part of the description and illustrate preferred embodiments of the invention. The drawings comprise the following figures.

FIG. 1 shows a perspective view of a torsion box of a horizontal tail plane according to an embodiment of the invention.

FIG. 2 shows a schematic span section of the torsion box of FIG. 1.

FIG. 3 shows a schematic partial chord section A-A of a lateral side of the torsion box according to the embodiment of FIG. 1 showing the cover and the spars located underneath.

FIG. 4A shows a perspective view of a torsion box of a horizontal tail plane according to an embodiment of the invention.

FIG. 4B shows a schematic partial span section B-B of an embodiment, a second portion of a skin located in the lateral right side of the torsion box of FIG. 4A and a portion of a cover.

FIG. 5 shows a schematic partial plan view of another embodiment of the spars, the second portion of a skin located in the lateral right side of a torsion box and a portion of a cover.

FIG. 6 shows a schematic partial span section B-B of the embodiment of FIG. 5.

FIG. 7 shows an embodiment of the assembly sequence of the embodiment shown in FIG. 6.

FIG. 8 shows a schematic partial plan view of another embodiment of the spars, the second portion of a skin located in the lateral right side of a torsion box and a portion of a cover.

FIG. 9 shows a schematic partial span section B-B of the embodiment of FIG. 8.

FIG. 10A shows a perspective view of a torsion box of a horizontal tail plane according to an embodiment of the invention.

FIG. 10B shows a schematic span section C-C of an embodiment of a central rib of the torsion box of FIG. 10A.

FIG. 11 shows a schematic span section C-C of another embodiment for the central rib of the torsion box of FIG. 10A.

FIG. 12 shows an embodiment of the assembly sequence of the central rib of the embodiment shown in FIG. 11.

FIG. 13 shows an embodiment of the demolding process in a schematic span section A-A of a torsion box.

FIG. 14 shows an embodiment of the demolding process in a schematic partial chord section B-B of a lateral side of the torsion box showing the opening and the spars located underneath.

### DETAILED DESCRIPTION OF THE PREFERRED EMBODIMENTS

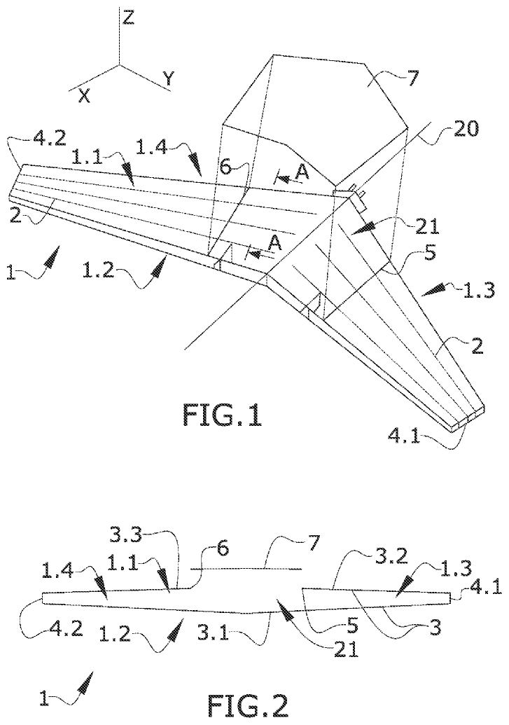

FIGS. 1 and 2 disclose an embodiment of the invention. The composite multi-spar aircraft lifting surface comprises an integrated torsion box (1) having:
A first face (1.1) and a second face (1.2) spaced in a Z-direction of the torsion box (1). The first face (1.1) would be the upper side and the second face (1.2) would be the lower side.
A lateral right side (1.3) and a lateral left side (1.4) on each side of a longitudinal direction (20).

The shown torsion box (1) comprises:
spars (2) located in the lateral left side (1.4) and in the lateral right side (1.3) and running spanwise, and
a skin (3).

More specifically, the torsion box (1) comprises the skin (3) configured as follows:
A first portion of the skin (3.1) being continuous and located in the second face (1.2) of the torsion box (1). It may be located in the upper side or in the lower side of the torsion box (1). The first portion of the skin (3.1) spans from a right tip (4.1) of the lateral right side (1.3) to a left tip (4.2) of the lateral left side (1.4) of the torsion box (1).
A second portion of the skin (3.2) located in the lateral right side (1.3) of the first face (1.1). This second portion of the skin (3.2) is located in the upper side if the first portion of the skin (3.1) running tip-to-tip is located in the lower side, for instance. The second portion of the skin (3.2) spans from the right tip (4.1) of the lateral right side (1.3) to a first central portion (5) of the span of the torsion box (1).
A third portion of the skin (3.3) located in the lateral left side (1.4) of the first face (1.1). Equally, this third portion of the skin (3.3) is located in the first face (1.1) of the torsion box (1) as the second portion of the skin (3.2). The third portion of the skin (3.3) spans from the left tip (4.2) of the lateral left side (1.4) to a second central portion (6) of the span of the torsion box (1).
A cover (7) spanning between the first central portion (5) and the second central portion (6) of the span of the torsion box (1).

The opening (21) between the first central portion (5) and the second central portion (6) is configured for providing access to the multi-cell structure of the torsion box (1), during some steps of the manufacturing, and is closed with the cover (7) towards the end of the manufacturing process. Such access may also be of use in maintenance or repair tasks of the aircraft.

As previously stated, the spars (2), the first portion of the skin (3.1), the second portion of the skin (3.2) and the third portion of the skin (3.3) are configured as an integrated multi-cell part in one piece. Thus, the manufactured torsion box (1) comprises two pieces, the integrated multi-cell structure and the cover (7) that closed the access to the inside of the integrated multi-cell structure.

In the shown embodiment, the opening (21) between the first central portion (5) and the second central portion (6), and therefore the cover (7), is symmetrically located with respect to a longitudinal direction (20) of the torsion box (1).

In an embodiment, the cover (7) is joined to the spars (2) by fastening means, for instance, by rivets.

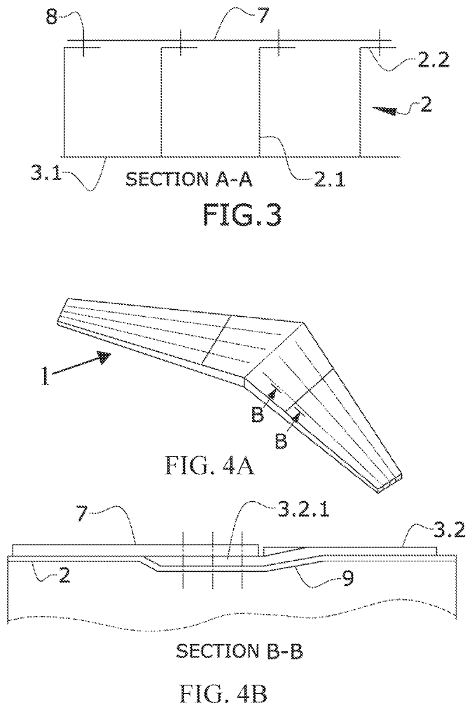

FIG. 3 discloses an embodiment of the spars (2) of the torsion box (1) and their joint to the cover (7).

At least one spar (2) has an L-shaped cross-section comprising a web (2.1) and a lateral flange (2.2) extending laterally from the web (2.1). The chord length of the flange (2.2) is smaller than a chordwise distance between said spar (2) and a consecutive spar (2) in the direction of the lateral flange (2.2).

In the shown embodiment, in the opening (21) between the first central portion (5) and the second central portion (6) the chord length of the flanges (2.2) is smaller than the distance between consecutive spars (2). For instance, the chord length of the flanges (2.2) is approximately less than half the distance between consecutive spars (2). The gap between the flanges (2.2) and the next spar (2) allows the extraction of a tooling as it will be explained below. In the shown embodiment, the cover (7) is fastened to the flanges (2.2) of the spars (2). This configuration allows an automatic riveting by, for example, High-Strength (HS) blind fasteners.

Alternatively, the spars (2) may have a T-shape or L-shape but towards each other such that a gap is formed between the respective edges of the flanges.

FIGS. 4A to 9 show different embodiments for the joint between the cover (7) and the second portion of the skin (3.2) or the third portion of the skin (3.3).

It has to be noted that there is a mechanical discontinuity between the second portion of the skin (3.2) and the cover (7) and between the third portion of the skin (3.3) and the cover (7). In an embodiment, they are adapted to each other so as to form an aerodynamically continuous skin.

FIGS. 4A and 4B discloses an integrated solution for the cover (7) and the skin portion adjacent to the first central portion (5).

The second portion of the skin (3.2) and/or the third portion of the skin (3.3) comprises a sloped section (9) along the span direction. More particularly, the sloped section (9) is performed towards the center of the torsion box (1), i.e., towards the opposite direction of the cover (7).

Therefore, an edge (3.2.1) of the second portion of the skin (3.2) adjacent to the first central portion (5) or an edge of the third portion of the skin (3.3) adjacent to the second central portion (6) is located between an edge of the cover (7) and one or more spars (2). Thus, the cover (7) is joined to, respectively, the second portion of the skin (3.2) and/or the third portion of the skin (3.3) at the sloped section (9).

The slope (9) is a smooth slope so that it does not interfere with the demolding process. This embodiment ensures continuity and a good transfer of loads between parts.

In the shown embodiment, the spar (2) also comprises a sloped section along the span direction.

As previously stated, although the embodiment shown in FIG. 4 discloses the second portion of the skin (3.2), the integrated solution for the cover (7) and the skin portion may also be applied to the second central portion (6) involving the third portion of the skin (3.3), its corresponding spars (2) and the cover (7).

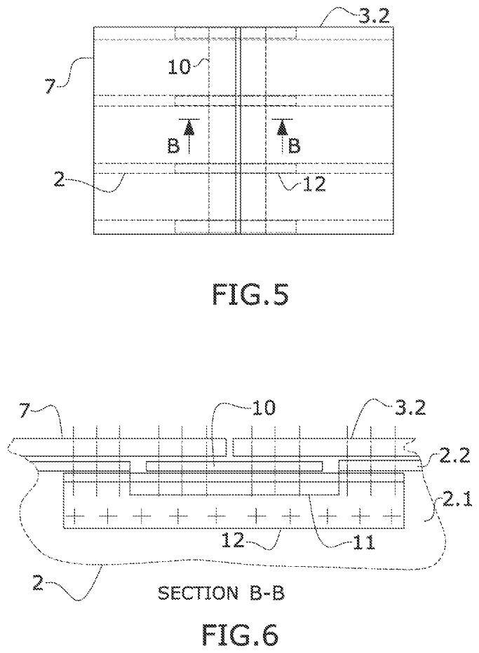

FIGS. 5 to 9 disclose a different embodiment wherein the cover (7) is fastened by, for instance, rivets. The embodiment comprises a strap (10), for instance, a butt strap, located in the chordwise direction of the torsion box (1).

The strap (10) is joined at the first central portion (5) by fastening means, such as rivets, to:
the cover (7), and
the second portion of the skin (3.2).

In the shown embodiment, the strap (10) is located at the first central portion (5) of the torsion box (1) at the interface between the cover (7) and the second portion of the skin (3.2). Likewise, the strap (10) may also be located at the second central portion (6) of the torsion box (1) at the interface between the cover (7) and the third portion of the skin (3.3).

FIGS. 5 and 6 disclose an embodiment wherein the spars (2) comprise a recess (11) in the Z-direction along its span direction. The Z-direction of the torsion box (1) is perpendicular to the span and the chord directions of the torsion box (1).

The strap (10) is located in the recesses (11) of the spars (2). Therefore, the cross-section of the strap (10) is located between the spars (2) and a portion of the cover (7) and the second portion of the skin (3.2) or the third portion of the skin (3.3).

In the shown embodiment, the torsion box (1) comprises a stiffener (12) joined to the spar (2) along the span direction and adapted for stiffening the spar (2).

The stiffener (12) is longitudinally joined to the spar (2) in the span direction and partially covers the recess (11) in the Z-direction of the spar (2) for stiffening the spar (2). Thus, the stiffener (12) reduces the size of the recess (11) and reinstates the stiffness of the spar (2).

Therefore, the recess (11) is deeper than the thickness of the strap (10) in the Z-direction and the stiffener (12) is fastened such that the strap (10) is pressed between the stiffener (12) and a portion of the cover (7) and the second portion of the skin (3.2).

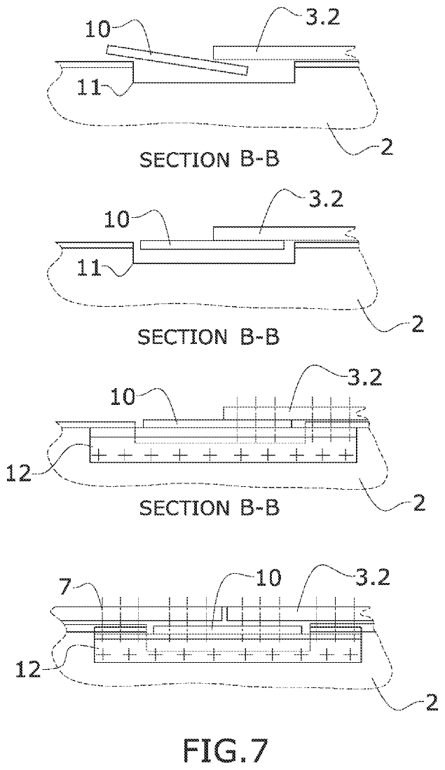

The function of an oversized recess (11) is to provide space for the strap (10) to be positioned in the recess (11) during the manufacturing process. This can be seen in the manufacturing sequence of FIG. 7. It has to be noted that the spars (2), the first portion of the skin (3.1) and the second portion of the skin (3.2) are configured as an integrated multi-cell part in one piece. Therefore, the strap (10) needs to be introduced in the space between the second portion of the skin (3.2) and the recess (11) of the spar (2). The second portion of the skin (3.2) is cantilevered over the recess (11) of the spar (2). In order for the strap (10) to maneuver, the size of the recess (11) needs to be oversized with respect to the cross-section of the strap (10).

The stiffener (12) may be joined to the cover (7) or alternatively to the second portion of the skin (3.2) or to the third portion of the skin (3.3). In an additional alternative, it can also be joined to the strap (10).

More specifically, the recess (11) is deeper than the thickness of the strap (10) in the Z-direction. The stiffener (12) is located such that the strap (10) is adjacent to the stiffener (12) and fastened to it (12).

The assembly sequence of the strap (10) is shown in FIG. 7:
a) The strap (10) is introduced and installed through the cover (7) access, i.e., through the opening (21) between the first central portion (5) and the second central portion (6). At this stage the cover (7) is not yet installed.
b) A stiffener (12) is introduced and installed below the strap (10) and along a spar (2).
c) The cover (7) is installed and attached with, for instance, blind rivets.

Some attachments may be common to the attachment of the skin (3.2), the cover (7), the strap (10) and the stiffener (12), thereby joining there three parts together at once. Some other attachments may be common to the attachment of the skin (3.2), the cover (7), the spar (2) and the stiffener (12), thereby joining there three parts together at once.

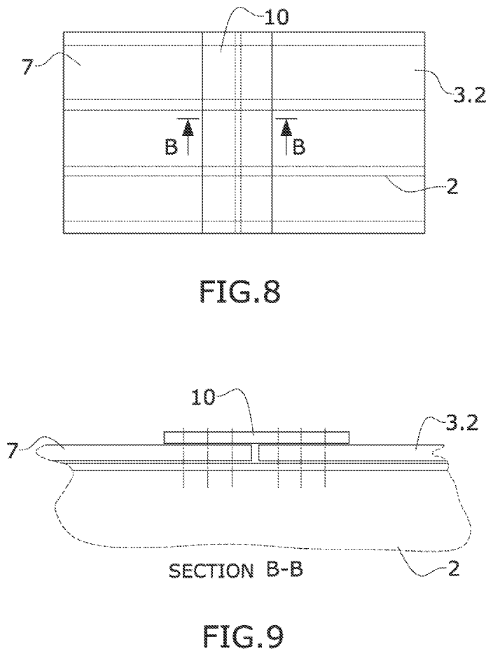

FIGS. 8 and 9 show another embodiment for the joint between the cover (7) and the adjacent portions of the skin (3). This embodiment is preferred when the joint is performed inside the fuselage of the aircraft. This embodiment simplifies the joint due to the absence of aerodynamic requirements as it is installed inside the fuselage. For this reason, the strap (10) can be installed outside the torsion box (1).

In this embodiment, the cover (7) and second portion of the skin (3.2) or the third portion of the skin (3.3) are located between the strap (10) and the spar (2) in the Z-direction.

As previously stated, although the embodiment shown in FIGS. 4 to 9 discloses the second portion of the skin (3.2), the joint between the cover (7) and the adjacent portion of the skin (3) may also be applied to the second central portion (6) involving the third portion of the skin (3.3), its corresponding spars (2) and the cover (7).

The claimed invention also has the advantage that the central joint of the torsion box (1) is optimized. Thanks to the continuous skin (3) on both sides, upper side and lower side, it is not necessary to transfer the entire load between the right and left torsion boxes (1), as is the case in a typical central joint. This allows a lighter central rib (13), lighter skins (3) in the central portion of the torsion box (1) and reduces the number of fasteners.

Thus, the torsion box (1) comprises a rib (13) located between the lateral right side (1.3) and the lateral left side (1.4) of the torsion box (1). In the shown embodiment, the rib (13) extends longitudinally chordwise. In the shown embodiment, the rib (13) has a double-T shape, although other shapes are possible.

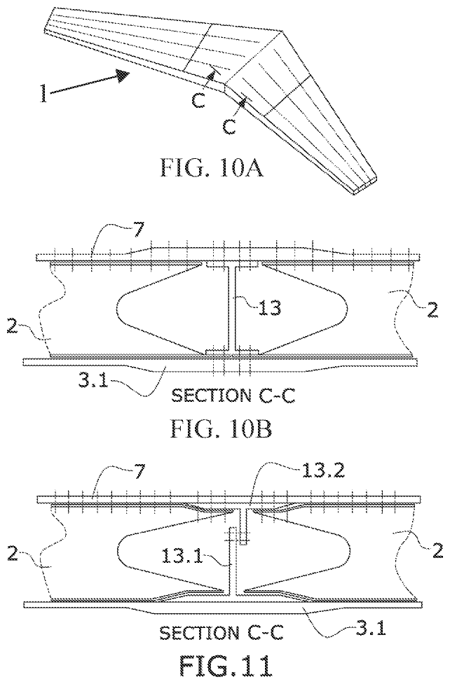

In the embodiment shown in FIGS. 10A and 10B, the rib (13) is fastened to the cover (7) and to the first portion of the skin (3.1). More specifically, one of the flanges of the rib (13) is rivetted to the cover (7) and the other flange is rivetted to the continuous skin tip-to-tip.

FIG. 11 shows another embodiment for the rib (13). The rib (13) comprises at least two portions:
a first T-shaped portion (13.1) configured as part of the integrated multi-cell part together with the spars (2) and the first portion of the skin (3.1), and
a second T-shaped portion (13.2) fastened to the cover (7) and to the first T-shaped portion (13.1).

The first T-shaped portion (13.1) may be formed fresh together with the spars (2) and the first portion of the skin (3.1) and thus be integral with the first portion of the skin (3.1) and spars (2). The second T-shaped portion (13.2) is added and attached afterwards to first allow extraction of the tooling from within the integrated one-piece structure.

This second embodiment for the rib (13) has the advantage of less fasteners, although the manufacturing process is more complex.

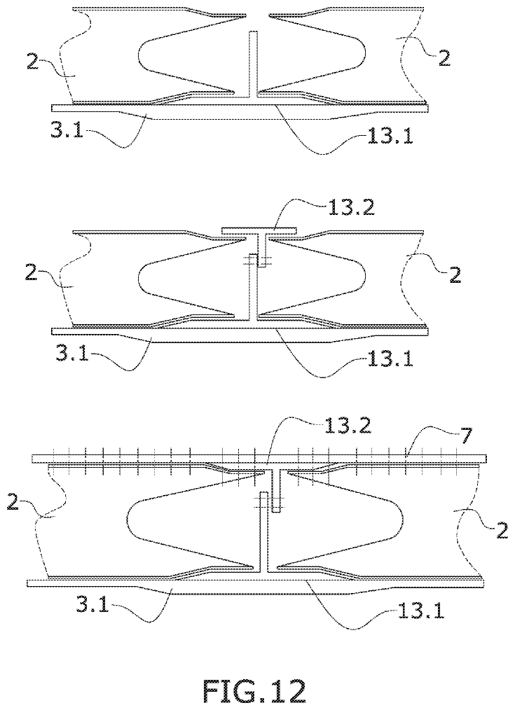

FIG. 12 shows the assembly sequence.

In a first step, the first T-shaped portion (13.1), the spars (2) and the first portion of the skin (3.1) are co-cured.

In a second step, the second T-shaped portion (13.2) is fastened to the first T-shaped portion (13.1).

In a third step, the cover (7) is fastened to the spars (2) and to the second T-shaped portion (13.2), for instance, with blind fasteners.

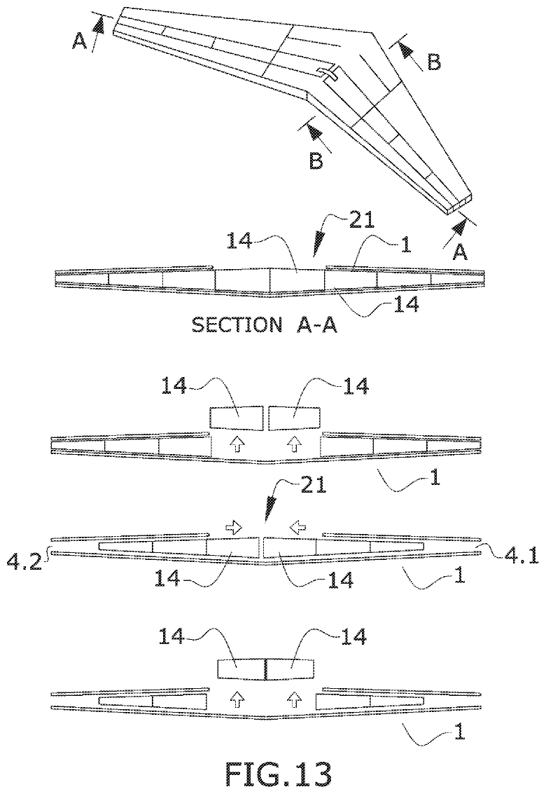

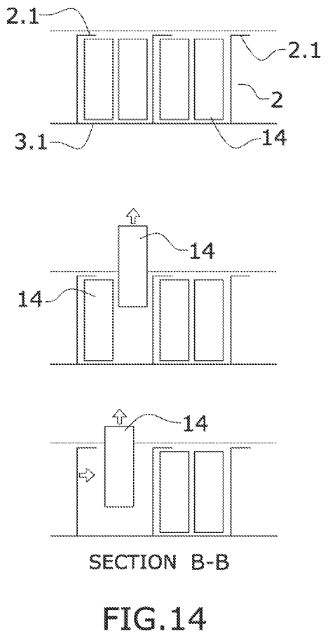

FIGS. 13 and 14 disclose an embodiment of the demolding process of the torsion box (1).

FIG. 13 discloses an embodiment of the demolding process. The method comprising the following steps:
providing a set of consecutive longitudinal tooling modules (14) located between adjacent spars (2), such that the set of consecutive longitudinal tooling modules (14) extends along the span of the torsion box (1),
curing the integrated multi-cell part,
removing through the opening (21) at least one of the consecutive longitudinal tooling modules (14) located between the first central portion (5) and the second central portion (6), i.e., located under the opening (21),
displacing in the span direction at least a next consecutive longitudinal tooling modules (14) towards the opening (21) between the first central portion (5) and the second central portion (6),
removing through the opening (21) the displaced consecutive longitudinal tooling module (14), said module (14) being located under the opening (21),
repeating the displacing and removing sequence until all the longitudinal tooling modules (4) have been removed through the opening (21), i.e., between the first central portion (5) and the second central portion (6).

Therefore, the consecutive longitudinal tooling modules (14) are displaced, for instance pushed, in the span direction towards the opening (21) between the first central portion (5) and the second central portion (6). The process is repeated several times until all the longitudinal tooling modules (14) have been removed through the opening (21) provided between the first central portion (5) and the second central portion (6).

In an embodiment, there could also be an access to the longitudinal tooling modules (14) through the right tip (4.1) and/or the left tip (4.2) zone of the torsion boxes (1) to push the consecutive longitudinal tooling modules (14) into the opening (21) between the first central portion (5) and the second central portion (6).

FIG. 14 discloses a chord section performed in the opening (21) between the first central portion (5) and the second central portion (6). At least one spar (2) has an L-shaped cross-section comprising a web (2.1) and a lateral flange (2.2) extending laterally from the web (2.1), the chord length of the flange (2.2) being smaller than a chordwise distance between said spar (2) and a consecutive spar (2) in the direction of the lateral flange (2.2). In the shown embodiment, three spars (2) are depicted.

A span schematic view is included in FIG. 14. At least two longitudinal tooling modules (14) are located between two consecutive spars (2) in the chord direction. Each longitudinal tooling module (14) has a chord length smaller than the chord distance between the flange (2.2) of the spar (2) and the web (2.1) of the adjacent spar (2). Thus, each tooling module (14) can be removed through the gap between the flange (2.2) and the web (2.1) of the adjacent spar (2) between the first central portion (5) and the second central portion (6), i.e., through the opening (21).

In the next step, one of the at least two longitudinal tooling modules (14) is removed through the gap between the flange (2.2) and the web (2.1) of the adjacent spar (2) for the tooling modules (14) located under the opening (21) between the first central portion (5) and the second central portion (6).

The other tooling module (14) of the at least two longitudinal tooling modules (14) located under the flange (2.2) of the spar (2) is displaced in a chordwise direction towards the gap between the flange (2.2) and the web (2.1) of adjacent spar (2) and is then removed through the gap between the flange (2.2) and the web (2.1) of the adjacent spar (2).

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

Claimed is:

1. A composite multi-spar aircraft lifting surface with an integrated torsion box comprising:
a first face and a second face,
a lateral right side and a lateral left side on each side of a longitudinal direction of the torsion box,
spars running spanwise in the lateral left side,
spars running spanwise in the lateral right side, and
a skin forming the first face and the second face,
wherein the torsion box comprises:
a first portion of the skin being continuous on the second face from a right tip of the lateral right side to a left tip of the lateral left side,
a second portion of the skin being continuous on the lateral right side of the first face, from the right tip to a first central portion of the torsion box,
a third portion of the skin being continuous on the lateral left side of the first face, from the left tip to a second central portion of the torsion box, and,
a cover spanning at least partially between the first central portion and the second central portion of the torsion box,
wherein the spars, the first portion of the skin, the second portion of the skin and the third portion of the skin are an integrated multi-cell part.

2. The composite multi-spar aircraft lifting surface according to claim 1, wherein the cover is symmetrically located with respect to the longitudinal direction of the torsion box.

3. The composite multi-spar aircraft lifting surface according to claim 1, wherein the cover is joined to the spars by fastening means.

4. The composite multi-spar aircraft lifting surface according to claim 1, wherein at least one spar has an L-shaped cross-section comprising a web and a lateral flange extending laterally from the web, a chord length of the flange being smaller than a chordwise distance between said at least one spar and a consecutive spar in a direction of the lateral flange.

5. The composite multi-spar aircraft lifting surface according to claim 1, wherein the second portion of the skin, or the third portion of the skin, or both comprise a sloped section along a span direction such that an edge of the second portion of the skin adjacent to the first central portion or an edge of the third portion of the skin adjacent to the second central portion is located between an edge of the cover and one or more spars and the slope section is adapted for joining the cover to, respectively, the second portion of the skin and/or the third portion of the skin.

6. The composite multi-spar aircraft lifting surface according to claim 1, further comprising:
a strap joined at the first central portion by fastening means to the cover and the second portion of the skin.

7. The composite multi-spar aircraft lifting surface according to claim 6, wherein the spars comprise a recess in a Z-direction along a span direction, the strap located in the recess such that the strap is located between the spars and a portion of the cover and the second portion of the skin.

8. The composite multi-spar aircraft lifting surface according to claim 7, wherein the torsion box comprises a stiffener joined to one of the spars along the span direction and configured to stiffen said spar.

9. The composite multi-spar aircraft lifting surface according to claim 8, wherein the recess is deeper than a thickness of the strap in the Z-direction and the stiffener is fastened such that the strap is pressed between the stiffener and a portion of the cover and the second portion of the skin.

10. The composite multi-spar aircraft lifting surface according to claim 6, wherein the cover and second portion of the skin are located between the strap and one of the spars in a Z-direction.

11. The composite multi-spar aircraft lifting surface according to claim 1, wherein the torsion box comprises a rib located between the lateral right side and the lateral left side of the torsion box, the rib fastened to the cover and to the first portion of the skin.

12. The composite multi-spar aircraft lifting surface according to claim 11, wherein the rib comprises at least two parts including:
a first T-shaped portion configured as part of the integrated multi-cell part together with the spars and the first portion of the skin, and
a second T-shaped part fastened to the cover and to the first T-shaped portion.

13. A method for manufacturing a composite multi-spar aircraft lifting surface, the lifting surface comprising an integrated torsion box with a first face and a second face, a lateral right side and a lateral left side on each side of a longitudinal direction of the torsion box, spars running spanwise in the lateral left side, spars running spanwise in the lateral right side, and a skin forming the first face and the second face, the method comprising the following steps:
manufacturing, in a first step, the torsion box as an integrated multi-cell part comprising:
the spars,
a first portion of the skin being continuous on the second face from a right tip of the lateral right side to a left tip of the lateral left side,
a second portion of the skin being continuous on the lateral right side of the first face, from the right tip to a first central portion of the torsion box, and
a third portion of the skin being continuous on the lateral left side of the first face, from the left tip to a second central portion of the torsion box, leaving an opening in the skin between the first central portion and the second central portion, fastening, in a second step, a cover spanning at least partially onto the opening.

14. The method for manufacturing a composite multi-spar aircraft lifting surface according to claim 13, further comprising the following steps:
providing a set of consecutive longitudinal tooling modules located between adjacent spars, such that the set of consecutive longitudinal tooling modules extends along the span of the torsion box,
curing the integrated multi-cell part,
removing through the opening at least one of the consecutive longitudinal tooling modules located between the first central portion and the second central portion,
displacing in a span direction at least a next consecutive longitudinal tooling module towards the opening between the first central portion and the second central portion,
removing through the opening the consecutive longitudinal tooling module, and,
repeating the displacing and removing sequence until all the longitudinal tooling modules have been removed through the opening.

15. The method for manufacturing a composite multi-spar aircraft lifting surface according to claim 13, wherein at least one spar has an L-shaped cross-section comprising a web and a lateral flange extending laterally from the web, a chord length of the flange being smaller than a chordwise distance between said at least one spar and a consecutive spar in the direction of the lateral flange, the method further comprising the following steps:
locating at least two longitudinal tooling modules between two consecutive spars in the chord direction, each longitudinal tooling module having a chord length smaller than a chord distance between the flange of the spar and the web of the adjacent spar so that each longitudinal tooling module is configured to be removed through a gap between the flange and the web of the adjacent spar and through the opening between the first central portion and the second central portion,
removing one of the at least two longitudinal tooling modules through the gap between the flange and the web of the adjacent spar for the longitudinal tooling modules located between the first central portion and the second central portion, and,
displacing the at least other longitudinal tooling module located under the flange of the spar in a chordwise direction towards the gap between the flange and the web of the adjacent spar and removing the at least other longitudinal tooling module through the gap between the flange and the web of the adjacent spar.
